(19) United States
(12) Patent Application Publication
(10) Pub. No.: US 2002/0066099 A1
(43) Pub. Date: May 30, 2002

(54) Display controlling apparatus and method, and storage medium

(76) Inventor: Tomoyuki Ohno, Kanagawa (JP)

Correspondence Address: ROBIN BLECKER & DALEY, 2ND FLOOR, 330 MADISON AVENUE, NEW YORK, NY, 10017, US

(21) Appl. No.: 09/995,378

(22) Filed: Nov. 26, 2001

(30) Foreign Application Priority Data
Nov. 30, 2000 (JP) 365834/2000

(51) Int. Cl. H04N 7/16; H04N 5/445; G06F 13/00

(52) U.S. Cl. 725/39; 725/135

(57) ABSTRACT

A display controlling apparatus of the present invention is for controlling a display apparatus which displays TV program information, and comprises receiving means for receiving program information on a plurality of programs, display control means for controlling so as to display first program information on the plurality of programs on the basis of the program information received by the receiving means on display means, and selection means for selecting first program information relating to an arbitrary program in the first program information displayed on the display means, wherein the display control means is constructed so as to control so as to display second program information on a program relating to the first program information selected by the selection means, and controls so as to display the second program information on a plurality of the selected programs.

### BACKGROUND OF THE INVENTION

1. Field of the Invention

The present invention relates to display controlling apparatus and methods for controlling apparatus capable of displaying program information, e.g., display apparatus capable of displaying EPG (Electronic Program Guide) transmitted in digital television broadcasting, and storage media storing processing steps for implementing it so as to be readable by computers.

2. Description of the Related Art

In digital satellite television (TV) broadcasting currently performed using a communication satellite (CS) or a broadcasting satellite (BS), as a part of audience service, EPG (Electronic Program Guide) is transmitted together with video and audio data. Besides, also in ground wave digital TV broadcasting scheduled in future, it is thinkable that the above EPG service is performed. Note that in the below description, digital satellite TV broadcasting, ground wave digital TV broadcasting, etc., are simply referred to as “digital TV broadcasting” in a lump.

Here, by the fact that digital TV broadcasting is multi-channel broadcasting, EPG is very useful information as channel selection information for users. For example, on the receiver side, by displaying EPG contained in received data on a screen, a user can easily grasp broadcasting times of programs, detailed contents of programs, genres, charge information, etc., from the contents on the display screen.

FIG. 17 illustrates the construction of a conventional digital TV broadcasting receiver 900.

As illustrated in the above FIG. 17, the receiver 900 has a construction in which a tuner unit 901, a descrambler 902, a demultiplexer 903, a video decoder 904, an audio decoder 905, an EPG decoder 906, a memory 907, an EPG screen composition unit 908, a display control unit 909, a digital/analogue converter (DAC) 910, an image display unit 912, a voice output unit 913, an operation unit 914, a light-receiving unit 915, a remote controller 916, an IC card control unit 917, a system control unit 918, a cursor designation distinction unit 919, and a cursor generating unit 920 are connected through a system bus 930.

The tuner unit 901 receives data from an antenna and performs processing of demodulation, error correction, etc., of the received data.

In case that scramble for audience limitation is applied to the data (transport stream (TS)) after processing in the tuner unit 901, the descrambler 902 cancels the scramble of TS on the basis of information from the IC card control unit 917 and information contained in the TS.

The demultiplexer 903 takes video data D1, audio data D2, and EPG data D3 of a desired channel out of TS from the descrambler 902, i.e., TS in which video data, audio data, EPG data, etc., for a plurality of channels are time-division-multiplexed, supplies the video data D1 to the video decoder 904, supplies the audio data D2 to the audio decoder 905, and supplies the EPG data D3 to the EPG decoder 906. The audio decoder 905 decodes the audio data D2 from the demultiplexer 903 and outputs it. The DAC 910 converts the output data of the audio decoder 905 into an analogue signal and then voice-outputs it through the voice output unit 913. Although the video decoder 904 decodes the video data D1 (data coded by MPEG2 or the like) from the demultiplexer 903 and the EPG decoder 906 similarly decodes the EPG data D3 from the demultiplexer 903, these decode and reproduction will be described below more specifically.

First, the EPG data D3 is mainly composed of data concerning a network name, channel numbers (or names), broadcasting times, program titles, program contents, charge information, current time, and so on. Besides, the EPG data D3 can not directly perform screen display and on the basis of this EPG data D3, EPG display data D4 for screen display must be generated. More specifically, data necessary for composing EPG is transmitted by a data structure regulated by “IEC13818-1MPEG2 SYSTEM”, a standard “program arrangement information used in digital broadcasting” by Association of Radio Industries and Businesses (popular name ARIB), and so on.

In the above data structures, as principal data structures for composing EPG, the following data structures can be mentioned:

NIT (Network Information Table) by which information on the physical construction of TS transmitted by a network, information indicating the name and characteristics of the network itself, etc., are transmitted.

SDT (Service Description Table) by which information on the names of drawing-up channels, the name of a broadcasting industry, and drawing-up channels is transmitted.

BAT (Bouquet Association Table) by which information on bouquet such as the name of a bouquet (a group of drawing-up channels), contained drawing-up channels, and so on, etc., are transmitted.

EIT (Event Information Table) by which information on program such as title, broadcasting start data and time, explanation of contents, and so on is transmitted.

TDT (Time Date Table) by which information on current data and time, etc., are transmitted.

As for TDT, for example, it is received by the receiver 900, and if the current date and time in the receiver 900 is incorrect, it is corrected (updated) to the date and time shown by TDT.

So, although the EPG decoder 906 generates EPG display data D4 by decoding the EPG data D3 from the demultiplexer 903, the EPG data D3 is once stored in the memory 907 before being supplied to the EPG decoder 906. And, in case that instructions for EPG display are given, the EPG data D3 stored in the memory 907 is input to the EPG decoder 906. The EPG decoder 906 decodes the EPG data D3 from the memory 907 to generate EPG display data D4, and supplies it to the EPG screen composition unit 908. The EPG screen composition unit 908 composes an EPG screen on the basis of the EPG display data D4 from the EPG decoder 906.

FIG. 18 illustrates processing for EPG screen composition by the EPG screen composition unit 908.

First, when an instruction for displaying EPG is input from a user through the operation unit 914 as a user interface or through the light-receiving unit 915 from the remote controller 916, by the input instruction, the system control unit 918 performs the following operation control for displaying EPG (step 1001).

By the operation control of the system control unit 918, the EPG decoder 906 generates EPG display data D4 by decoding the EPG data D3 output from the memory 907 as described above, and supplies it to the EPG screen composition unit 908. The EPG screen composition unit 908 takes in SDT from the EPG display data D4 from the EPG decoder 906, and acquires information on check of the presence/absence information on programs belonging to a channel, channel names of its and other streams, channel numbers, etc., indicated by the SDT (step 1002).

Besides, the EPG screen composition unit 908 takes in EIT from the above EPG display data D4, and acquires information on program titles in each channel of its and other streams, the start times, genres, explanation of the programs, charge information, etc., indicated by the EIT (step 1003). And, the EPG screen composition unit 908 composes an EPG screen on the basis of the information acquired in step 1002 and step 1003 (step 1004). Although the details will be described later, the display control unit 909 performs control for display-outputting on the image display unit 912 the EPG screen obtained by the EPG screen composition unit 908 (step 1005). Note that as for NIT describing information on network name and so on and TDT describing information on current date and time and so on, assuming that they are acquired in general when the receiver 900 is powered on, processing concerning this is omitted from the flowchart of the above FIG. 18.

Processing of step 1005 illustrated in the above FIG. 18 will be described more specifically. First, the display control unit 909 is supplied with the EPG screen obtained by the EPG screen composition unit 908 and video data D1 decoded by the video decoder 904. The display control unit 909 switches the data of the EPG screen and the video data after decoding with each other and displays them to the image display unit 912, or performs control for OSD (On Screen Display) displaying the EPG screen to the image display unit 912.

FIG. 19 illustrates an example of display screen (EPG screen 1100) on the image display unit 912 by the control of the display control unit 909. In the above FIG. 19, reference numeral “1101” denotes a display area for indicating channel names or channel number, and reference numeral “1102” does a time axis for specifying the start and end times of each channel program. Reference numeral “1103” denotes a selection cursor for selecting a desired program in each channel program, and reference numeral “1104” does an area for displaying the channel name or channel, number, program title, broadcasting date and time, program contents, genre, charge information, etc., of the program selected by the selection cursor 1103. Reference numeral “1105” denotes a display area for indicating the current date and time, and reference numeral “1106” does a display area for indicating the name of the network currently selected. The selection cursor 1103 is generated by the cursor generating unit 920 (see the above FIG. 17), and is capable of its movement, designation of an arbitrary area, and so on, by the operation unit 914 or the remote controller 916.

FIGS. 20A and 20B illustrate the constructions of the operation unit 914 and the remote controller 916. In the above FIGS. 20A and 20B, reference numeral “1201” denotes a light-receiving unit for performing an infrared communication between the remote controller 916 and the light-receiving unit 915 of the receiver 900 (see the above FIG. 17). Reference numeral “1202” denotes a 10-key for inputting a channel number or the like, and reference numeral “1203” does an EPG display button for displaying an EPG screen. Reference numerals “1204a to 1204d” denote cursor buttons for moving the selection cursor 1103 (see the above FIG. 19) upward, downward, leftward, and rightward, and reference numeral “1205” does a determination button for performing a determination of an area selection designated by the selection cursor 1103.

By operating the operation unit 914 and the remote controller 916 as illustrated in the above FIGS. 20A and 20B, in the image display unit 912, the user can perform display of the EPG screen 1100, movement of the selection cursor 1103, selection of a channel, and so on.

For example, in the EPG screen 1100 of the above FIG. 19, the following information can be recognized:

that the current date and time is AM 6:32 of Nov. 17, 1998.

the programs to be broadcasted between AM 6:00 and AM 10:00 in the channel numbers 101 to 107.

the contents of the program “cooking 5” scheduled to be broadcasted from AM 8:00 to AM 10:00 in 107 channel.

In the state of the EPG screen 1100 of the above FIG. 19, by operating the cursor buttons 1204a to 1204d of the operation unit 914 or the remote controller 916, if the selection cursor 1103 is moved rightward, the EPG screen 1100 is scrolled in a direction of the time axis (a lateral direction). By this, the EPG screen after AM 10:00 can be displayed. Also, if the selection cursor 1103 is moved downward, the EPG screen 1100 is scrolled in a direction of the channel display axis (a vertical direction). By this, display of the EPG screen after 107 channel and display of the EPG screen after 10:00 can be performed.

By the operation as described above, out of the program names displayed by the EPG screen 1100, the user selects an audience selection candidate program (adjusts the selection cursor 1103), refers detailed information on the audience selection candidate program displayed to the display area 1104, and by the determination button 1205, true-selects (audience-determines) the audience selection candidate program as a program to be actually viewed.

In the conventional receiver 900 as shown in the above FIG. 17, however, though the channels broadcasted in digital TV broadcasting reach several hundreds, only part of information can be displayed in the EPG screen 1100, as illustrated in the above FIG. 19.

In the example of screen of the above FIG. 19, only displayed are the program titles corresponding to about four hours in relation to seven channels of 101 channel to 107 channel. Besides, in the display area 1104, although detailed information attendant upon a program (information on the contents of the program, the genre of the program, the charge information for the program, the broadcasting time of the program, etc.) is displayed, it corresponds to only one program and detailed information attendant upon another program is not displayed.

Therefore, the user could not easily and efficiently select a desired program with comparing detailed information attendant upon each program (information on the contents of the program, the genre of the program, the charge information for the program, the broadcasting time of the program, etc.), in a great number of channels or programs.

### SUMMARY OF THE INVENTION

Under such a background, the present invention is to solve the problems as described above, and aims to provide a display controlling apparatus and method, and a storage medium storing processing steps for implementing it so as to be readable by a computer, wherein a user can easily and efficiently select a desired program.

These objectives are achieved by the provision of a display controlling apparatus for controlling a display apparatus which displays TV program information according to a preferred embodiment of the present invention which has receiving means for receiving program information on a plurality of programs, display control means for controlling so as to display first program information on the plurality of programs on the basis of the program information received by the receiving means on display means, and selection means for selecting first program information relating to an arbitrary program in the first program information displayed on the display means, wherein the display control means controls so as to display second program information on a program relating to the first program information selected by the selection means, and controls so as to display the second program information on a plurality of the selected programs.

Objects and characteristic features other than the above of the present invention will become apparent from the detailed description of embodiments of the invention with reference to the following drawings.

### BRIEF DESCRIPTION OF THE DRAWINGS

FIG. 1 is a block diagram illustrating the construction of a receiver for digital TV broadcasting to which the present invention is applied in the first embodiment;

FIG. 2 is a view for explaining an example (example 1) of EPG (Electronic Program Guide) screen in the above receiver;

FIGS. 3A and 3B are views for explaining the constructions of an operation unit and a remote controller of the above receiver;

FIG. 4 is a view for explaining an example (example 2) of EPG screen in the above receiver;

FIG. 5 is a view for explaining an example (example 3) of EPG screen in the above receiver;

FIG. 6 is a view for explaining an example (example 4) of EPG screen in the above receiver;

FIG. 7 is a view for explaining an example (example 5) of EPG screen in the above receiver;

FIG. 8 is a view for explaining an example (example 6) of EPG screen in the above receiver;

FIG. 9 is a view for explaining an example (example 7) of EPG screen in the above receiver;

FIG. 10 is a block diagram illustrating the construction of a receiver for digital TV broadcasting to which the present invention is applied in the second embodiment;

FIG. 11 is a view for explaining an example (example 1) of EPG screen in the above receiver;

FIGS. 12A and 12B are views for explaining the constructions of an operation unit and a remote controller of the above receiver;

FIG. 13 is a view for explaining an example (example 2) of EPG screen in the above receiver;

FIG. 14 is a view for explaining an example (example 3) of EPG screen in the above receiver;

FIG. 15 is a view for explaining an example (example 4) of EPG screen in the above receiver;

FIG. 16 is a view for explaining an example (example 5) of EPG screen in the above receiver;

FIG. 17 is a block diagram illustrating the construction of a conventional receiver for digital TV broadcasting;

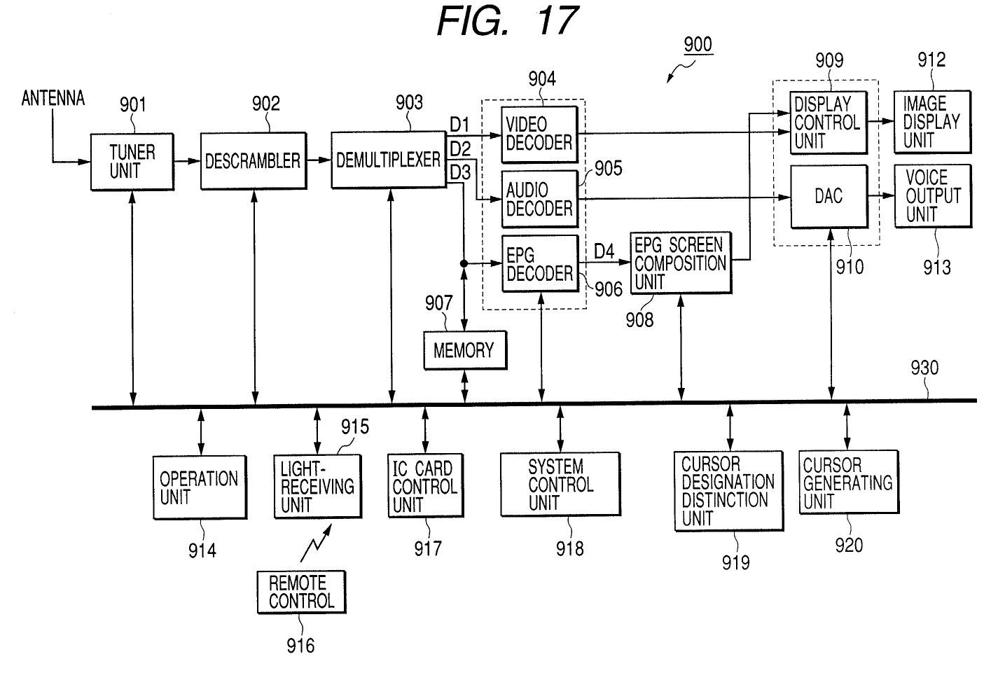

FIG. 18 is a flowchart for explaining processing for EPG screen composition in the above receiver;

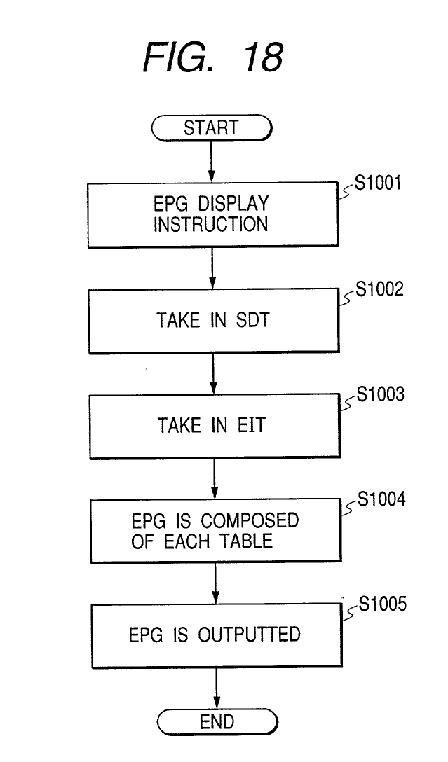

FIG. 19 is a view for explaining an example of EPG screen in the above receiver; and

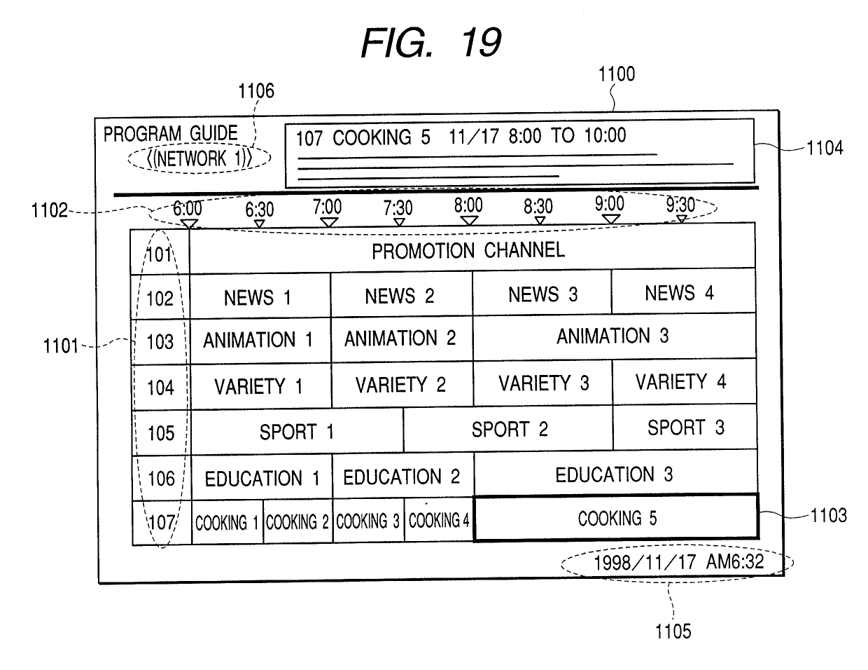

FIGS. 20A and 20B are views for explaining the constructions of an operation unit and a remote controller of the above receiver.

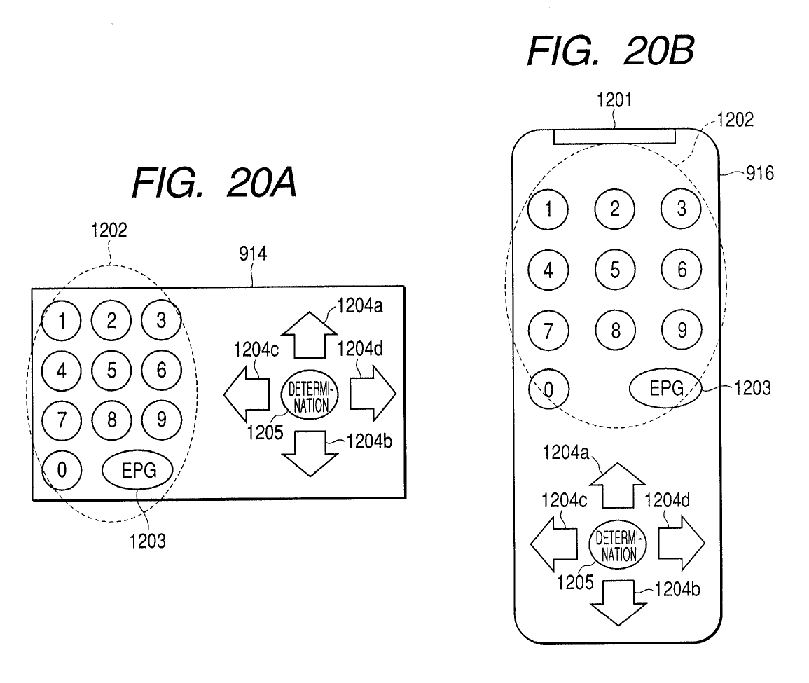

### DETAILED DESCRIPTION OF THE PREFERRED EMBODIMENTS

Hereinafter, embodiments of the present invention will be described with reference to drawings.

(First Embodiment)

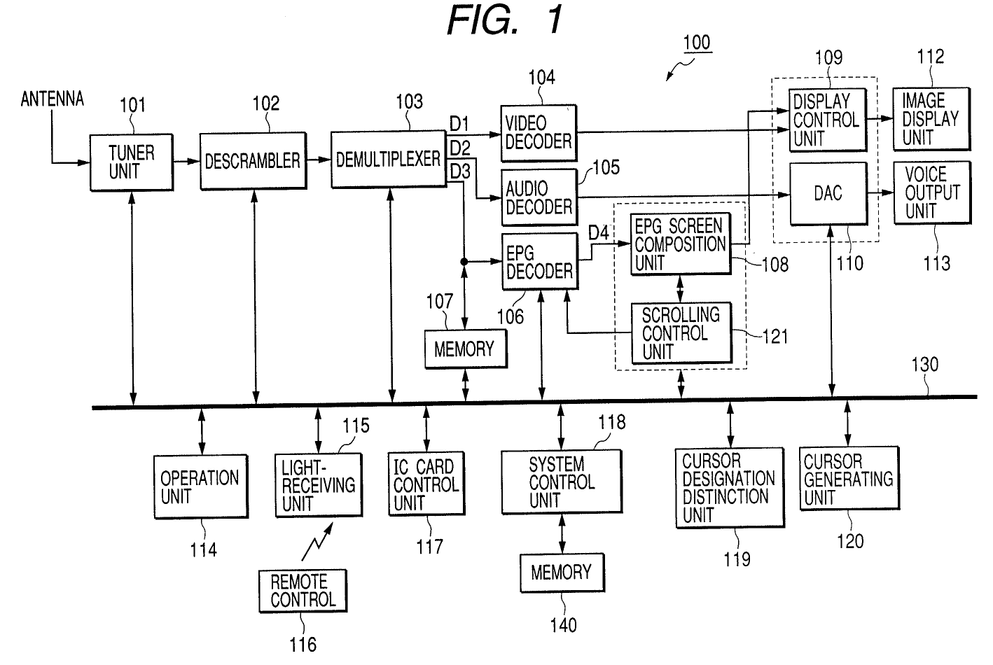

For example, the present invention is applied to a receiver 100 for digital TV broadcasting as illustrated in FIG. 1.

<Whole Construction of Receiver 100>

As illustrated in the above FIG. 1, the receiver 100 of this embodiment has a construction in which a scrolling control unit 121 as well as a tuner unit 101, a descrambler 102, a demultiplexer 103, a video decoder 104, an audio decoder 105, an EPG decoder 106, a memory 107, an EPG screen composition unit 108, a display control unit 109, a digital/analogue converter (DAC) 110, an image display unit 112, a voice output unit 113, an operation unit 114, a light-receiving unit 115, a remote controller 116, an IC card control unit 117, a system control unit 118, a cursor designation distinction unit 119, and a cursor generating unit 120 is connected through a system bus 130.

Besides, the whole operation of the receiver 100 of this embodiment is controlled by the system control unit 118. For example, the system control unit 118 performs operation control of the receiver 100 as described later by reading out and executing a processing program stored in advance in a memory 140.

<Series of Operations of Receiver 100>

First, the tuner unit 101 receives data from an antenna and performs processing of demodulation, error correction, etc., of the received data. In case that scramble for audience limitation is applied to the data (transport stream (TS)) after processing in the tuner unit 101, the descrambler 102 cancels the scramble of TS on the basis of information from the IC card control unit 117 and information contained in the TS.

The demultiplexer 103 takes video data D1, audio data D2, and EPG data D3 of a channel selected by a user out of TS from the descrambler 102, i.e., TS in which video data, audio data, EPG data, etc., for a plurality of channels are time-division-multiplexed, supplies the video data D1 to the video decoder 104, supplies the audio data D2 to the audio decoder 105, and once stores the EPG data D3 in the memory 107.

The audio decoder 105 decodes the audio data D2 from the demultiplexer 103 and outputs it to the DAC 110. The DAC 110 converts the output data of the audio decoder 105 into an analogue signal and then voice-outputs it through the voice output unit 113.

The video decoder 104 decodes the video data D1 (data coded by MPEG2 or the like) from the demultiplexer 103 and supplies the video data D1 after decoding to the display control unit 109. The EPG data D3 stored in the memory 107 is supplied to the EPG decoder 106 by the control from the system control unit 118 when a display instruction of an EPG screen is issued from the user. The EPG decoder 106 generates EPG display data D4 by decoding the EPG data D3 from the memory following the control from the scrolling control unit 121 the details of which will be described later, and supplied it to the EPG screen composition unit 108.

The EPG screen composition unit 108 composes an EPG screen using the EPG display data D4 from the EPG decoder 106 following the control from the scrolling control unit 121 the details of which will be described later, and supplies it to the display control unit 109. The display control unit 109 switches the data of the EPG screen from the EPG screen composition unit 108 and the video data from the video decoder 104 after decoding with each other and displays them to the image display unit 112, or performs control for OSD (On Screen Display)-displaying the EPG screen to the image display unit 112.

<Characteristic Construction and Operation of Receiver 100>

The receiver 100 is constructed so that in a state that attendant information concerning the first program selected from the user as an audience program candidate is fixedly displayed in an arbitrary area on the EPG screen, by the scrolling control unit 121, the receiver 100 displays the EPG screen for selecting a subsequent audience program candidate, and displays attendant information concerning the second program selected by the user from the EPG screen together with the attendant information concerning the first program on the dame screen. Here, attendant information is detailed information concerning the program such that the contents, genre, performers' names, charge information, broadcasting time, etc., of the program.

By this, the user becomes possible to select a desired program more easily with comparing the attendant information on the first program selected as the audience program candidate and the attendant information on the second program selected as the audience program candidate after that. Hereinafter, such a construction and operation as a characteristic feature of this embodiment will be described more specifically.

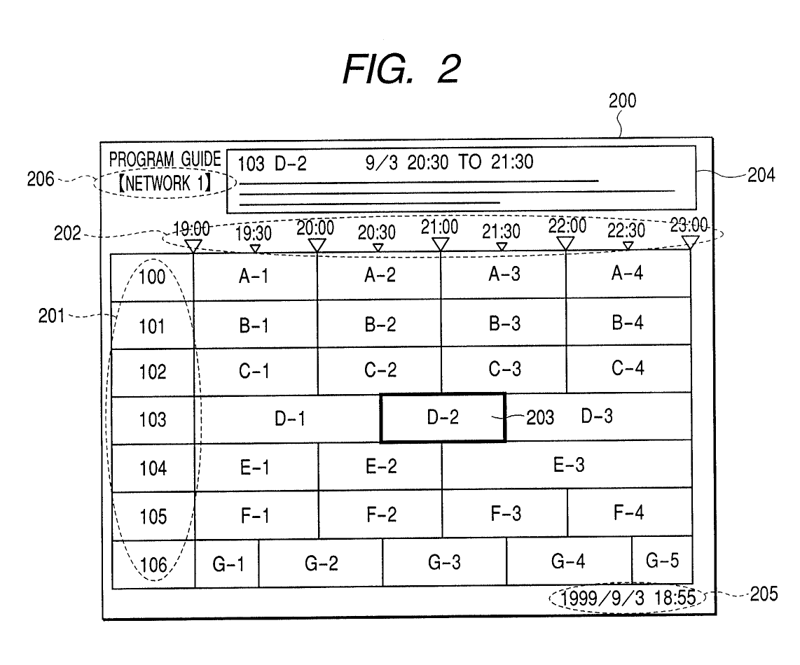

FIG. 2 illustrates an example of EPG screen (EPG screen 200) composed by the EPG screen composition unit 108. In the above FIG. 2, reference numeral “201” denotes a display area for indicating channel names or channel number, and reference numeral “202” does a time axis for specifying the start and end times of each channel program. And, on the basis of a channel number axis and the time axis, items for selecting each program are list-displayed. Here, the item of each program is a display such as D-2, A-1, or the like in the figure, and for example, the program title of each program.

Reference numeral “203” denotes a selection cursor for selecting a desired program in each channel program, and reference numeral “204” does an area for displaying the channel name or channel, number, program title, broadcasting date and time, program contents, genre, charge information, etc., of the program selected by the selection cursor 203. Reference numeral “205” denotes a display area for indicating the current date and time, and reference numeral “206” does a display area for indicating the name of the network currently selected. The selection cursor 203 is generated by the cursor generating unit 120 (see the above FIG. 1), and capable of its movement, designation of an arbitrary area, and so on, by the operation unit 114 or the remote controller 116.

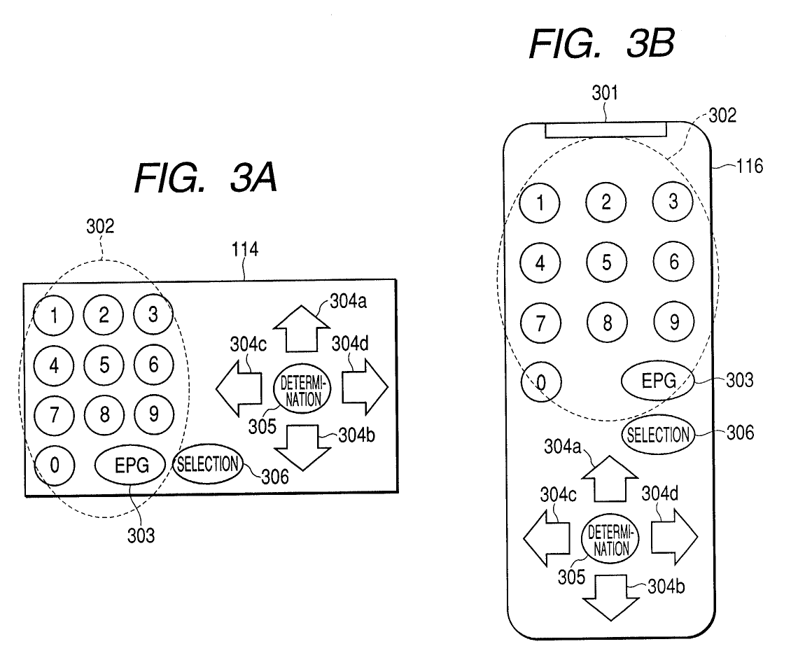

FIGS. 3A and 3B illustrate an example of constructions of the operation unit 114 and the remote controller 116. In the above FIGS. 3A and 3B, reference numeral “301” denotes a light-receiving unit for performing an infrared communication between the remote controller 116 and the light-receiving unit 115 of the receiver 100 (see the above FIG. 1). Reference numeral “302” denotes a 10-key for inputting a channel number or the like, and reference numeral “303” does an EPG display button for displaying an EPG screen. Reference numerals “304a to 304d” denote cursor buttons for moving the selection cursor 203 (see the above FIG. 2) upward, downward, leftward, and rightward, and reference numeral “305” does a determination button for performing a determination of an area selection designated by the selection cursor 203. Reference numeral “306” denotes a selection button the details of which will be described later.

Note that although the above FIGS. 3A and 3B illustrate only buttons for performing operations for implementing main functions as an example of this embodiment, the present invention is not limited to this. Besides, in the operation unit 114 of the above FIG. 3A and the remote controller 116 of the same figure B, the same reference numerals are added to the buttons that functions in the same manner.

In the EPG screen 200 of the above FIG. 2, the selection cursor 203 is located at the position of a program D-2 to be broadcasted in the time zone from 20:30 to 21:30 of 103 channel (channel of the channel number “103”). In this case, in the display area 204 displayed is attendant information (program detail information) on the program D-2, more specifically, information on the channel name through which the program D-2 is broadcasted, the channel number, the program title, the broadcasting date and time, the program contents, the genre, the charge information, and so on. In the state of the EPG screen 200 of the above FIG. 2, if the determination button 305 of the operation unit 114 or the remote controller 116 is depressed, the audience of the program D-2 becomes possible. Note that in the above FIG. 2, since the current date and time and time indicated by the display area 205 is before the broadcasting time of the program D-2, in this case, an audience reservation, a recording reservation, or the like of the program D-2 is performed.

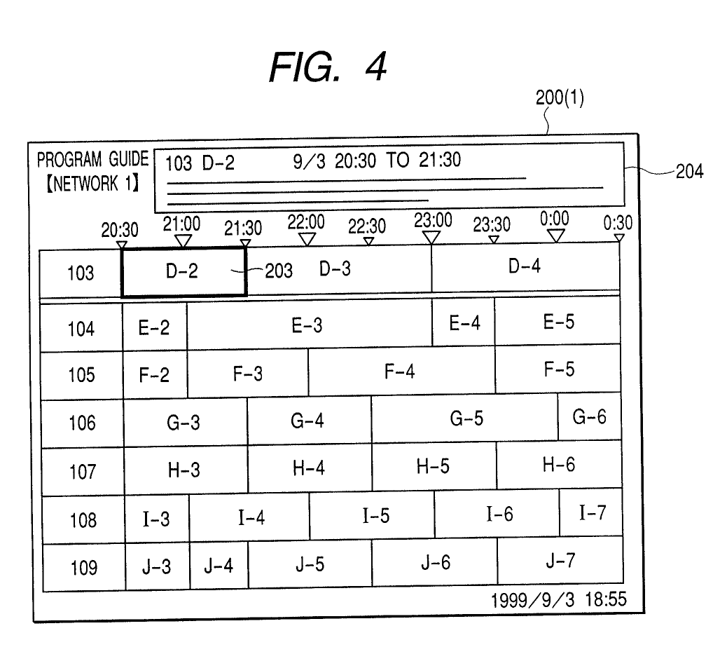

In the state of the EPG screen 200 of the above FIG. 2, when the selection button 306 of the operation unit 114 or the remote controller 116 is depressed, the EPG screen 200 changes to the display state illustrated in FIG. 4. The EPG screen 200(1) of the above FIG. 4 is in the state that the original EPG screen 200 has been scrolled in both directions of the time axis and channel axis so that the item of the program D-2 selected by the selection cursor 203 may be displayed at the upper-leftmost.

The above scrolling process is performed by the scrolling control unit 121. More specifically, the scrolling control unit 121 designates EPG data necessary to be displayed after scrolling processing from cursor position information (positional information on the selection cursor 203) from the cursor designation distinction unit 119, to the EPG decoder 106.

Therefore, the EPG decoder 106 takes out and decodes EPG data designated from the scrolling control unit 121 from TS supplied through the demultiplexer 103 and the memory 107, and then sends out it to the EPG screen composition unit 108. The EPG screen composition unit 108 receives the data from the EPG decoder 106, composes an EPG screen from the data, and sends out it to the display control unit 109. The display control unit 109 displays the EPG screen from the EPG screen composition unit 108 by the image display unit 112.

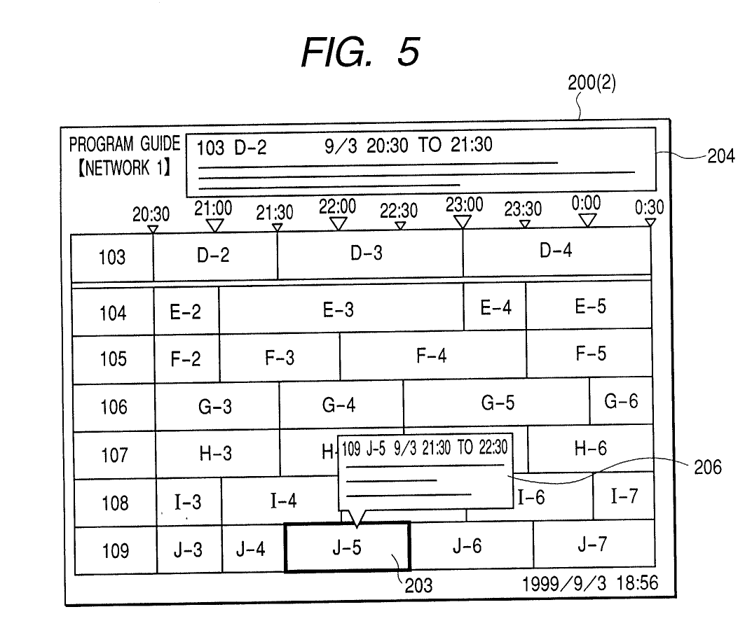

In the state of the EPG screen 200(1) of the above FIG. 4, by operating the cursor buttons 304a to 304d of the operation unit 114 or the remote controller 116, it becomes possible to move the selection cursor 203 and select another program. For example, by this operation, in case that another program J-5 is selected, the EPG screen 200(1) of the above FIG. 4 changes to the display state illustrated in FIG. 5.

In the EPG screen 200(2) of the above FIG. 5, the selection cursor 203 is located at the position of the program J-5 to be broadcasted in the time zone from 21:30 to 22:30 in 109 channel. Besides, in the display area 204, the program attendant information on the program D-2 previously selected remains in the displayed state, and in this state, program attendant information on the program J-5 selected this time is popup-displayed on the same EPG screen 200(2), as shown by “206” in the figure.

Therefore, the user can perform an audience determination with easily comparing the program attendant information on the program D-2 previously selected and the program attendant information on the program J-5 selected next with each other on the same EPG screen 200(2). For example, to perform the audience determination of the program J-5, in the state of the EPG screen 200(2) of the above FIG. 5, the user may depress the determination button 305. Besides, to perform the audience determination of the program D-2, the user may locate the selection cursor 203 at the position of the program D-2 and depress the determination button 305.

Note that as operations for selection and/or determination of a program, the present invention is not limited to those by the selection cursor 203 and the determination button 305 as described above, and for example, channel/number may be directly input by the 10-key 302.

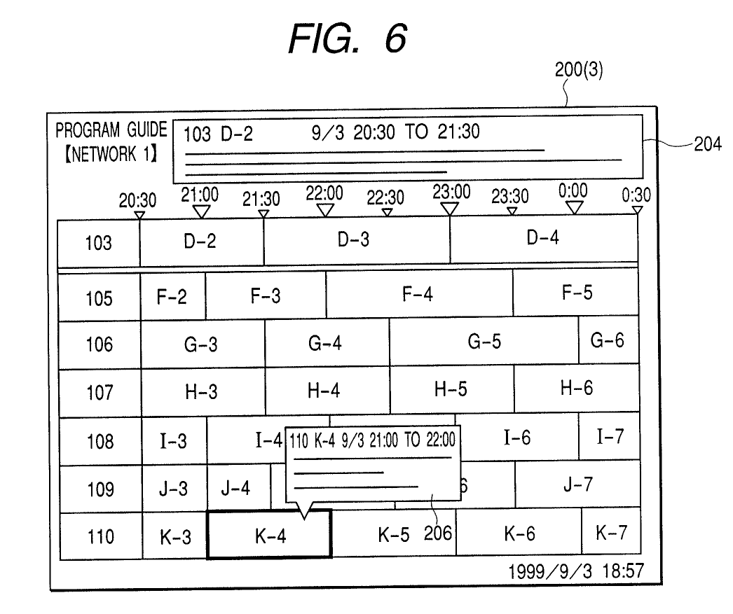

In the state of the EPG screen 200(2) of the above FIG. 5, when the cursor buttons 304a to 304d of the operation unit 114 or the remote controller 116 are operated and by the movement of the selection cursor 203, another program, for example, a program K-4 is selected, the EPG screen 200(2) of the above FIG. 5 changes to the display state illustrated in FIG. 6.

In the EPG screen 200(3) of the above FIG. 6, the selection cursor 203 is located at the position of the program K-4 to be broadcasted in the time zone from 21:00 to 22:00 in 110 channel.

Besides, in the display area 204, the program attendant information on the program D-2 selected first remains in the displayed state, and in this state, program attendant information on the program K-4 selected this time is popup-displayed on the same EPG screen 200(3), as shown by “206” in the figure.

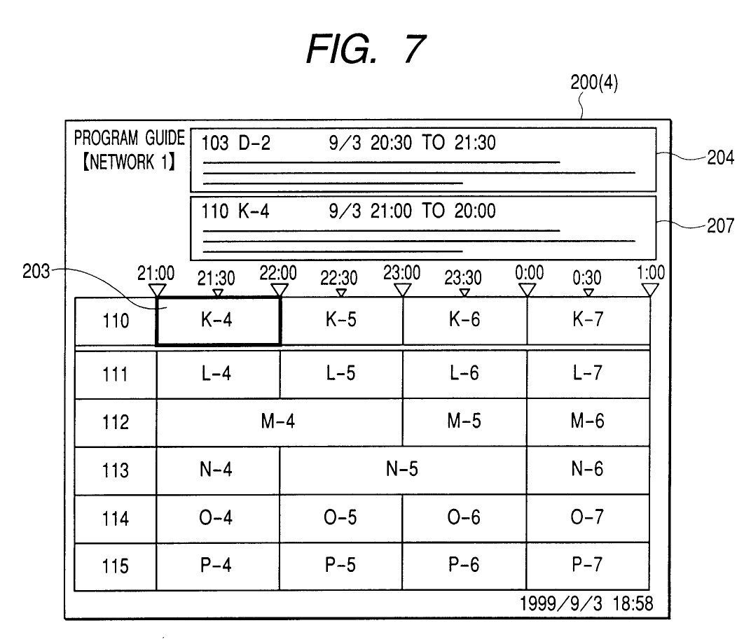

In the state of the EPG screen 200(3) of the above FIG. 6, when the selection button 306 of the operation unit 114 or the remote controller 116 is depressed, the EPG screen 200(3) of the above FIG. 6 changes to the display state illustrated in FIG. 7.

The EPG screen 200(4) of-the above FIG. 7 is in the state that the EPG screen 200(3) in the previous state has been scrolled in both directions of the time axis and channel axis so that the item of the program K-4 selected by the selection cursor 203 may be displayed at the upper-leftmost. Besides, in the EPG screen 200(4) of the above FIG. 7, the program attendant information on the program K-4 popup-displayed in the EPG screen 200(3) in the previous state is independently displayed to a display area 207 different from the display area 204 where the program attendant information on the program attendant information on the program D-2 is displayed.

In the state of the EPG screen 200(4) of the above FIG. 7, by operating the cursor buttons 304a to 304d of the operation unit 114 or the remote controller 116, it becomes possible to move the selection cursor 203 and select another program.

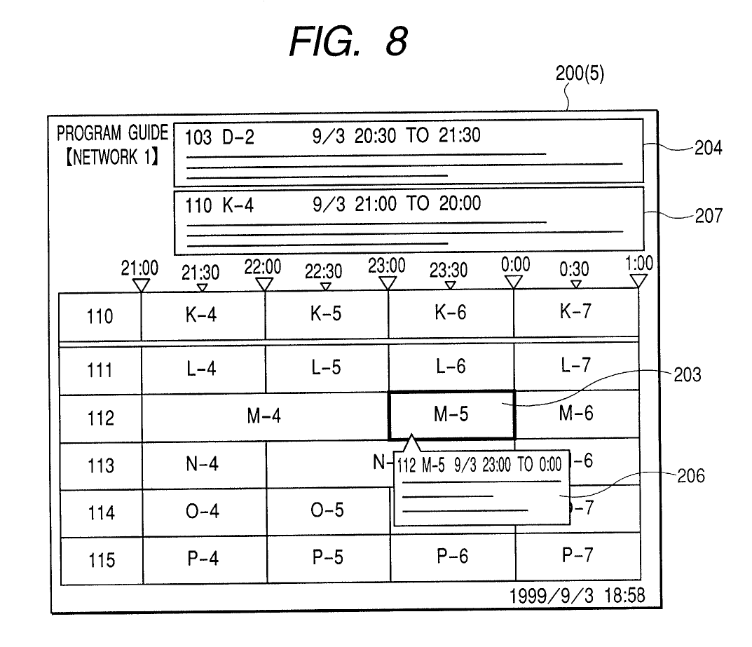

For example, by this operation, in case that another program M-5 is selected, the EPG screen 200(4) of the above FIG. 7 changes to the display state illustrated in FIG. 8.

In the EPG screen 200(5) of the above FIG. 8, the selection cursor 203 is located at the position of the program M-5 to be broadcasted in the time zone from 23:00 to 0:00 in 112 channel, and together with the program attendant information on the program D-2 and program K-4 displayed in the display area 204 and display area 207, program attendant information on the program M-5 selected this time is popup-displayed on the same EPG screen 200(5), as shown by “206” in the figure.

Therefore, the user can perform an audience determination with easily comparing the program attendant information on the M-5 selected this time together with the program D-2 and program K-4 selected previously.

Besides, in the state of the EPG screen 200(3) of the above FIG. 6, by moving the selection cursor 203 in a direction of the time axis by operating the cursor buttons 304a to 304d of the operation unit 114 or the remote controller 116, it is possible to perform a display with switching the time axis of the EPG display of 103 channel displayed previously with being fixed with the time axis of the EPG display of the other channel.

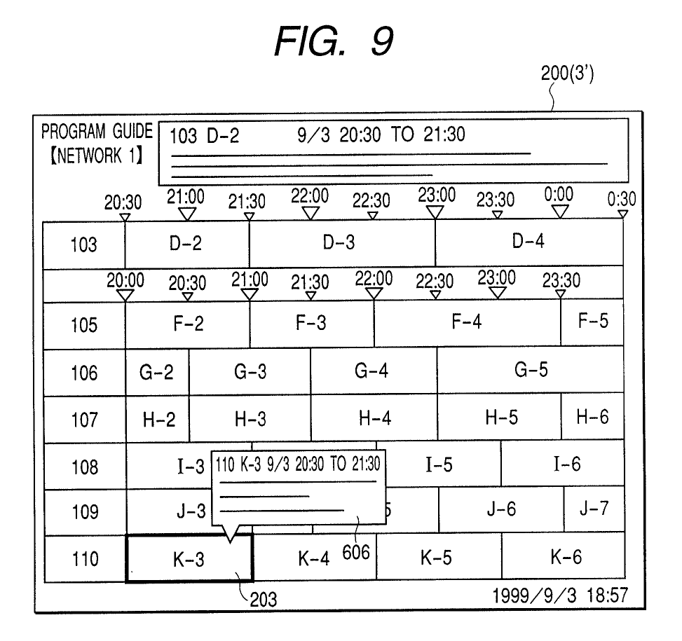

FIG. 9 illustrates a display screen 200 (3′) at this time. Also in this display screen 200 (3′), as described above, the program attendant information on the program K-3 at which the selection cursor 203 is located can be popup-displayed, and an audience determination can be performed with easily comparing this and the program attendant information on the program D-2 previously selected on the same screen 200 (3′).

As described above, in this embodiment, in an audience program selection by EPG (Electronic Program Guide), when a predetermined operation is performed from a user and the first program is selected as an audience program candidate, attendant information (program detail information) concerning the first program is fixedly displayed in an arbitrary area on the EPG screen, and in this display state, further, the second program, the third program, . . . , can be selected as audience program candidates on the EPG screen. Besides, if the second program is selected as the audience program candidate, in the state that the attendant information concerning the first program is fixedly displayed in the arbitrary area, attendant information concerning the second program is displayed on the same screen. After then, similarly in relation to the selection of the third program, in the state that the attendant information concerning the program previously selected is fixedly displayed in an arbitrary area, attendant information concerning the program selected this time is displayed on the same screen. By such a construction, with displaying the attendant information on a predetermined program in the EPG screen, further, attendant information on a program can selectively be displayed, and attendant information concerning a plurality of programs can be displayed on the same screen. Therefore, the user becomes possible to perform the selection of a desired program more easily with comparing the respective programs selected as the audience program candidates as the first program, the second program, the third program, . . . , by the attendant information.

(Second Embodiment)

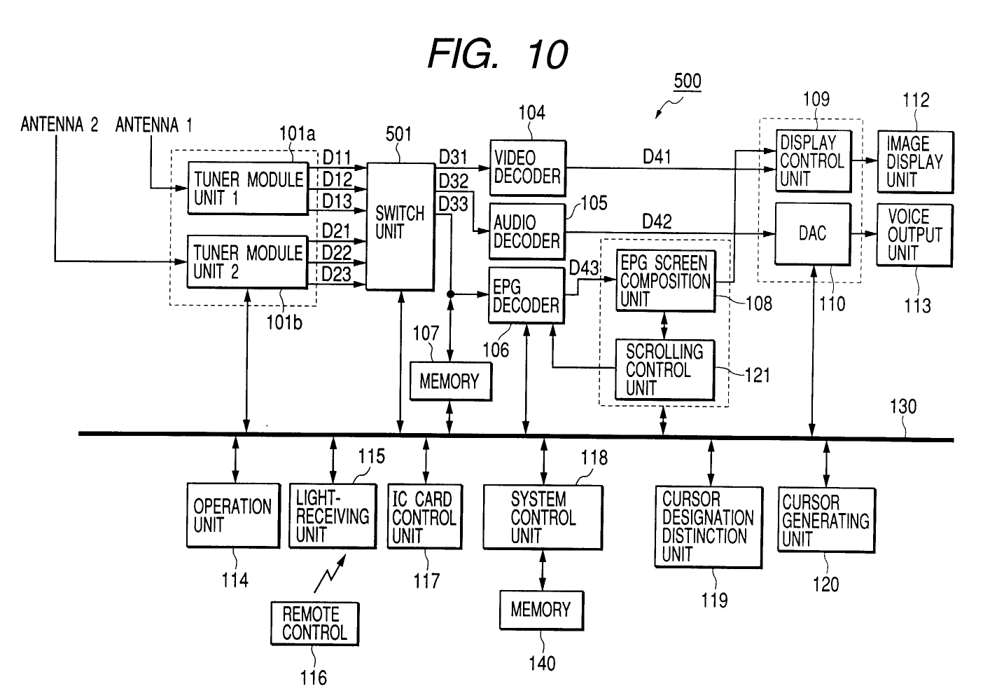

For example, the present invention is applied to a receiver 500 for digital TV broadcasting as illustrated in FIG. 10.

Note that in the receiver 500 of the above FIG. 10, the same reference numerals are assigned to the parts that operate in the same manner as in the receiver 100 of the above FIG. 1, and the detailed description thereof will be omitted. Here, only the construction different from the first embodiment will be described specifically.

The receiver 500 of this embodiment is provided with two tuner module units 101a and 101b connected so as to correspond to two antennas 1 and 2, respectively, and a switch unit 501 for outputting each output of the tuner module units 101a and 101b with being switched, wherein the output of the switch unit 501 is supplied to the video decoder 104, the audio decoder 105, and the EPG decoder 106, respectively.

The tuner module units 101a and 101b each have the same functions as the tuner unit 101, the descrambler 102, the demultiplexer 103, and so on.

Besides, to these tuner module units 101a and 101b, data input through the antennas 1 and 2 are different from each other in network as the transmission path of the data. For example, in the antenna 1, first digital TV broadcasting is received, and in the antenna 2, second digital TV broadcasting different from the first digital TV broadcasting is received. As the first and second digital TV broadcastings, various broadcastings such as BS digital TV broadcasting, CS digital TV broadcasting, ground wave digital TV broadcasting, cable digital TV broadcasting, and so on are applicable.

Therefore, the tuner module unit 101a takes out video data D11, audio data D12, and EPG data D13 of a channel selected from a user from data of the first digital TV broadcasting received by the antenna 1, and supplies these data D1, D12, and D13 to the switch unit 501. Besides, the tuner module unit 101b also takes out video data D21, audio data D22, and EPG data D23 of a channel selected from the user from data of the second digital TV broadcasting received by the antenna 2, and supplies these data D21, D22, and D23 to the switch unit 501.

The switch unit 501 selects one of the data D11, D12, and D13 from the tuner module unit 101a and the data D21, D22, and D23 from the tuner module unit 101b, and outputs the selected data as data D31, D32, and D33.

As for the data D31, D32, and D33 output from the switch unit 501, the data D31 is supplied to the video decoder 104 to be decoded, the data D32 is supplied to the audio decoder 105 to be decoded, and the data D33 is supplied through the memory 107 to the EPG decoder 106 to be decoded.

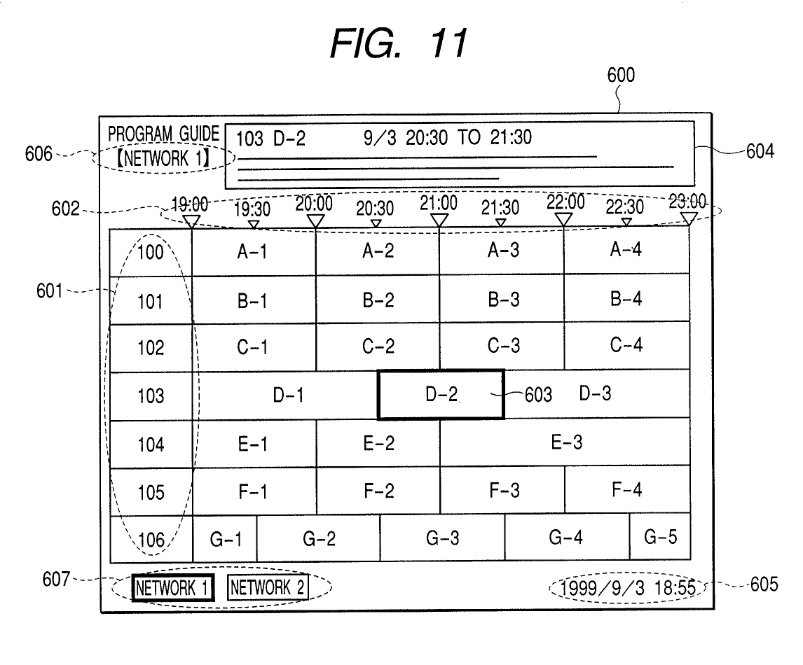

FIG. 11 illustrates an example of EPG screen (EPG screen 600) composed by the EPG screen composition unit 108 of this embodiment. In the above FIG. 11, reference numeral “601” denotes a display area for indicating channel names or channel number, and reference numeral “602” does a time axis for specifying the start and end times of each channel program.

Reference numeral “603” denotes a selection cursor for selecting a desired program in each channel program, and reference numeral “604” does an area for displaying the channel name or channel, number, program title, broadcasting date and time, program contents, genre, charge information, etc., of the program selected by the selection cursor 603.

Reference numeral “605” denotes a display area for indicating the current date and time, and reference numeral “606” does a display area for indicating the name of the network currently selected (“network 1” in the above FIG. 11). Reference numeral “607” denotes a display area for indicating the names of networks currently selectable. In the above FIG. 11, “network 1” and “network 2” are currently selectable, and for example, “network 1” corresponds to the antenna 1 and the tuner module unit 101a and “network 2” corresponds to the antenna 2 and the tuner module unit 101b. The selection cursor 603 is generated by the cursor generating unit 120 (see the above FIG. 10), and capable of its movement, designation of an arbitrary area, and so on, by the operation unit 114 or the remote controller 116.

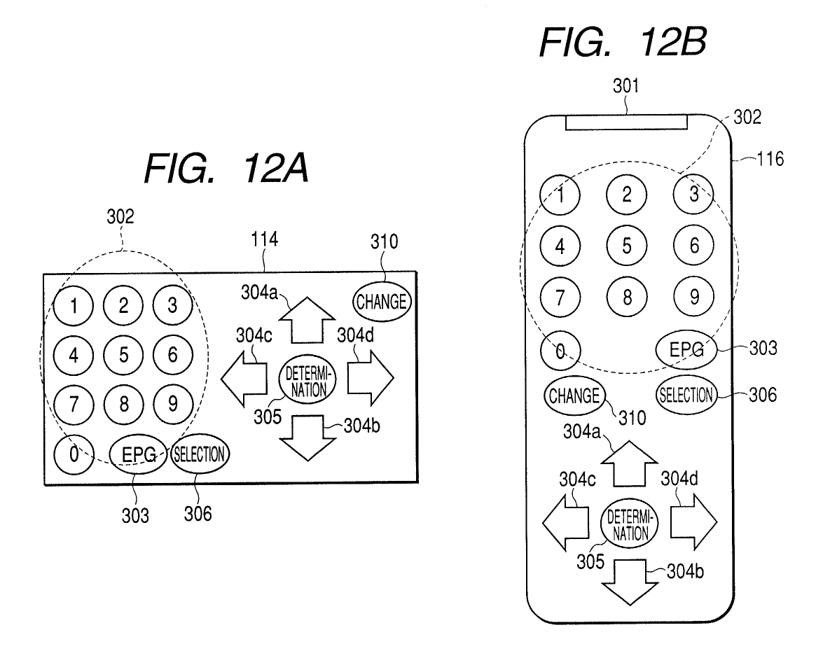

FIGS. 12A and 12B illustrate an example of constructions of the operation unit 114 and the remote controller 116 of this embodiment. Note that in the operation unit 114 and the remote controller 116 illustrated in the above FIGS. 12A and 12B, parts that function in the same manner as in the operation unit 114 and the remote controller 116 illustrated in the above FIG. 3 are denoted by the same reference numerals and the detailed description thereof is omitted. Besides, although the above FIGS. 12A and 12B illustrate only buttons for performing operations for implementing main functions as an example of this embodiment, the present invention is not limited to this. Besides, in the operation unit 114 of the above FIG. 12A and the remote controller 116 of the same figure B, the same reference numerals are added to the buttons that functions in the same manner.

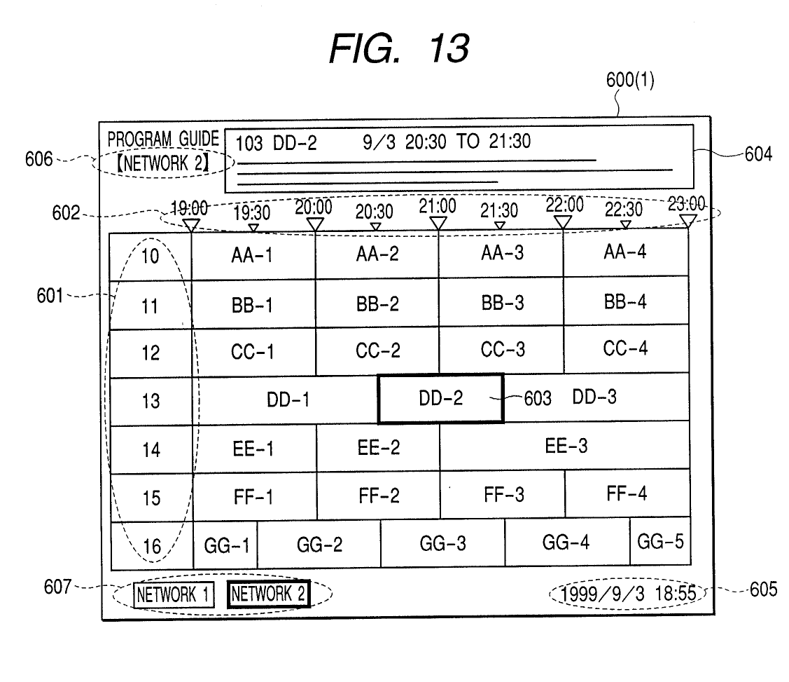

As illustrated in the above FIGS. 12A and 12B, the operation unit 114 and the remote controller 116 of this embodiment each have a construction that is further provided with a change button 310. The change button 310 is a button for switching the selection network between “network 1” and “network 2”, and for example, in the state that the EPG screen 600 of the above FIG. 11 is displayed, that is, in the state that the EPG screen 600 for “network 1”, by depressing the change button 310, as illustrated in FIG. 13, switching to an EPG screen 600(1) for “network 2” is possible.

In the EPG screen 600 of the above FIG. 11, the selection cursor 603 is located at the position of the program D-2 to be broadcasted in the time zone from 20:30 to 21:30 of 103 channel (channel of the channel number “103”). In this case, in the display area 604 displayed is the attendant information (program detail information) on the program D-2, more specifically, the information on the channel name through which the program D-2 is broadcasted, the channel number, the program title, the broadcasting date and time, the program contents, the genre, the charge information, and so on.

In the state of the EPG screen 600 of the above FIG. 11, if the determination button 305 of the operation unit 114 or the remote controller 116 is depressed, the audience of the program D-2 becomes possible. Note that in the above FIG. 11, since the current date and time and time indicated by the display area 205 is before the broadcasting time of the program D-2, in this case, an audience reservation, a recording reservation, or the like of the program D-2 is performed.

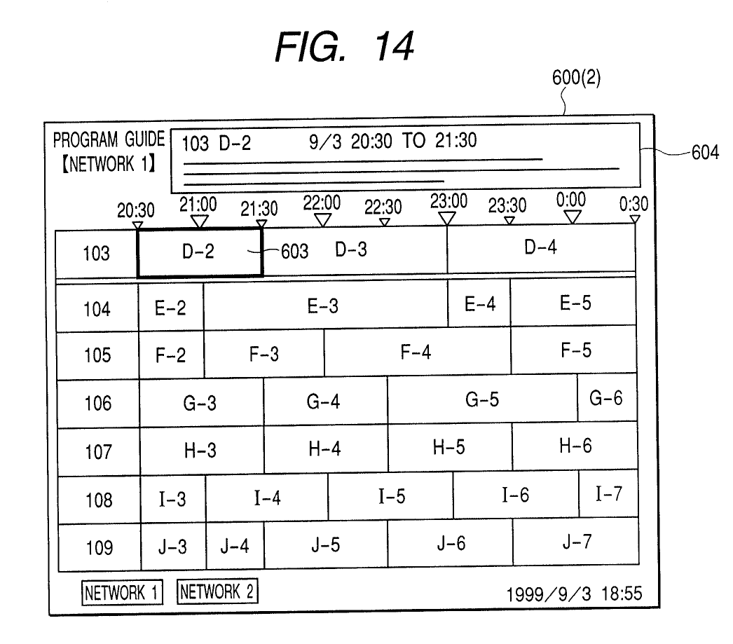

In the state of the EPG screen 600 of the above FIG. 11, when the selection button 306 of the operation unit 114 or the remote controller 116 is depressed, the EPG screen 600 changes to the display state illustrated in FIG. 14. The EPG screen 600(2) of the above FIG. 14 is in the state that the original EPG screen 600 has been scrolled in both directions of the time axis and channel axis so that the item of the program D-2 selected by the selection cursor 603 may be displayed at the upper-leftmost.

The above scrolling process is performed by the scrolling control unit 121. More specifically, the scrolling control unit 121 designates EPG data necessary to be displayed after scrolling processing from cursor position information (positional information on the selection cursor 603) from the cursor designation distinction unit 119, to the EPG decoder 106.

Therefore, the EPG decoder 106 takes out and decodes EPG data designated from the scrolling control unit 121 from TS (data D33) supplied through the tuner module unit 101a, the switch unit 501, and the memory 107, and then sends out it to the EPG screen composition unit 108. The EPG screen composition unit 108 receives the data from the EPG decoder 106, composes an EPG screen from the data, and sends out it to the display control unit 109. The display control unit 109 displays the EPG screen from the EPG screen composition unit 108 by the image display unit 112.

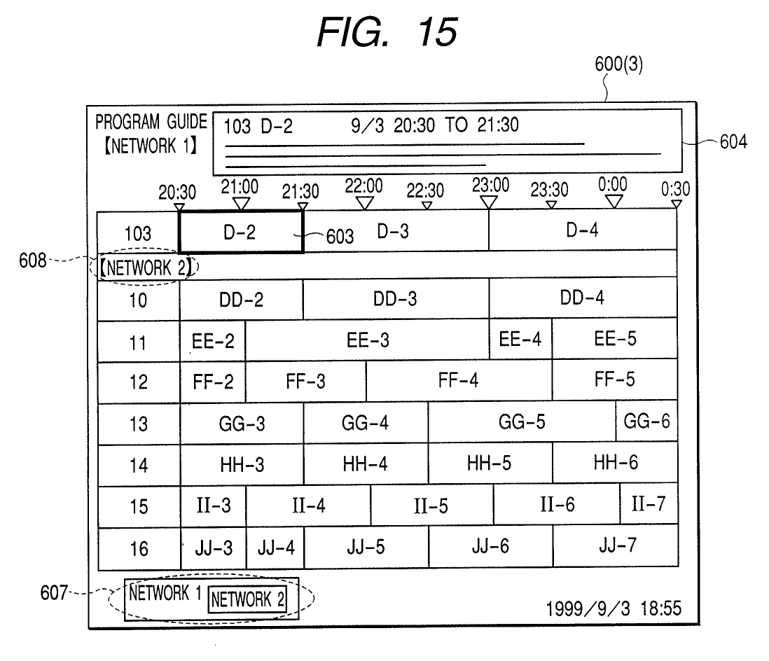

In the state of the EPG screen 600(2) of the above FIG. 14, when the change button 310 of the operation unit 114 or the remote controller 116 is depressed, the EPG screen 600(2) changes to the display state illustrated in FIG. 15. The EPG screen 600(3) of the above FIG. 15 is in the state that the EPG screen for “network 1” and the EPG screen for “network 2” different from “network 1” are displayed to the same screen 600(3).

The above display control is executed as follows. First, the scrolling control unit 121 requests EPG data necessary to be displayed after scrolling processing from cursor position information (positional information on the selection cursor 603) from the cursor designation distinction unit 119, to the system control unit 118 and the EPG decoder 106. The system control unit 118 performs an operation control for taking out EPG data necessary for the tuner module unit 101b to compose a desired EPG screen (EPG screen for “network 2”) from TS, as well as a switching control of the switch unit 501.

The EPG decoder 106 decodes the EPG data input by the control of the system control unit 118 to generate EPG display data D43. The EPG screen composition unit 108 composes an EPG screen (EPG screen for “network 2”) using the EPG display data D43 obtained in the EPG decoder 106, and supplies it to the display control unit 109. The display control unit 109 performs a control for displaying the EPG screen from the EPG screen composition unit 108 on the image display unit 112.

As a result of the display control as described above, on the image display unit 112 displayed is the EPG screen 600(3) as illustrated in FIG. 15. In the above FIG. 15, by reference numeral “608”, it is specified that the EPG screen displayed in the lower column concerns “network 2”, and in the display area 607, it is specified that each EPG screen of “network 1” and “network 2” is displayed on the same screen.

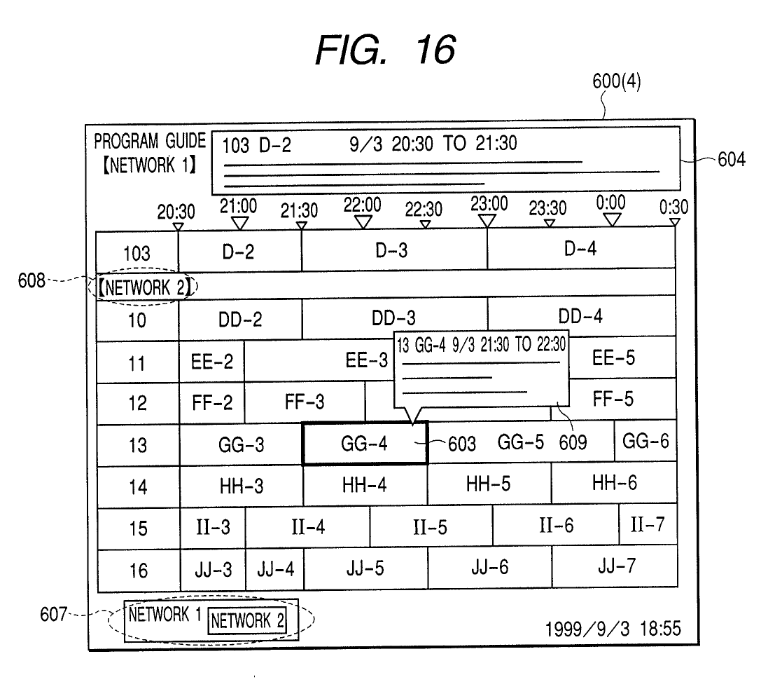

In the state of the EPG screen 600(3) of the above FIG. 15, when the cursor buttons 304a to 304d of the operation unit 114 or the remote controller 116 are operated and by the movement of the selection cursor 603, another program, for example, a program GG-4 in “network 2” is selected, the EPG screen 600(3) of the above FIG. 15 changes to the display state illustrated in FIG. 16.

In the EPG screen 600(4) of the above FIG. 16, the selection cursor 603 is located at the position of the program GG-4 to be broadcasted in the time zone from 21:30 to 22:30 in 13 channel of “network 2”. Besides, in the display area 604, the program attendant information on the program D-2 of “network 1” selected first remains in the displayed state, and in this state, program attendant information on the program GG4 of “network 2” selected this time is popup-displayed on the same EPG screen 600(4), as shown by “609” in the figure.

Therefore, the user can perform an audience determination with easily comparing the program attendant information on the program D-2 of “network 1” previously selected and the program attendant information on the program GG-4 of “network 2” selected next with each other on the same screen 600(4).

For example, to perform the audience determination of the program GG-4, in the state of the EPG screen 600(4) of the above FIG. 16, the user may depress the determination button 305. Besides, to perform the audience determination of the program D-2, the user may locate the selection cursor 603 at the position of the program D-2 and depress the determination button 305. Note that as operations for selection and/or determination of a program, the present invention is not limited to those by the selection cursor 603 and the determination button 305 as described above, and for example, channel/number may be directly input by the 10-key 302.

As described above, in this embodiment, in an audience program selection by EPG (Electronic Program Guide), when a predetermined operation is performed from a user and the first program existing on a certain network (“network 1”) is selected as an audience program candidate, attendant information (program attendant information) concerning the first program is fixedly displayed in an arbitrary area on the EPG screen, and in this display state, the second program, the third program, . . . , existing on a different network (“network 2”) or the same network can be selected as audience program candidates further on the EPG screen. Besides, if the second program of the different network (“network 2”) is selected as the audience program candidate, in the state that the attendant information concerning the first program of “network 1” is fixedly displayed in the arbitrary area, attendant information concerning the second program of “network 2” is displayed on the same screen. After then, similarly in relation to the selection of the third program, in the state that the attendant information concerning the program previously selected is fixedly displayed in an arbitrary area, attendant information concerning the program selected this time is displayed on the same screen.

By such a construction, with displaying the attendant information on a predetermined program in the EPG screen, further, attendant information on a program existing on a different network can selectively be displayed, and attendant information concerning a plurality of programs can be displayed on the same screen irrespective of the difference in network. Therefore, the user becomes possible to perform the selection of a desired program more easily with comparing the respective programs selected as the audience program candidates as the first program, the second program, the third program, . . . , by the attendant information.

Note that it is needless to say that the objects of the present invention are achieved by supplying a storage medium storing program codes of software that implement the functions of the host and terminal of the first and second embodiments, to a system or apparatus, and by a computer (or CPU or MPU) of the system or apparatus reading out and executing the program codes stored in the storage medium. In this case, the program codes themselves read out from the storage medium implement the functions of the first and second embodiments, and the storage medium storing the program codes constitutes the present invention. As the storage medium for supplying the program codes, a ROM, a floppy disk, a hard disk, an optical disk, a magneto-optical disk, a CD-ROM, a CD-R, a magnetic tape, a nonvolatile memory card, or the like can be used. Besides, it is needless to say that not only a case wherein the functions of the first and second embodiments are implemented by a computer executing the read-out program codes, but also a case wherein OS or the like operating on the computer performs part or all of the actual processes and the functions of the first and second embodiments are implemented by the processes is included.

Further, it is needless to say that a case wherein after the program codes read out from the storage medium are written in a memory provided in an extension function board inserted in the computer or a function extension unit connected to the computer, on the basis of instructions of the program codes, a CPU or the like provided in the function extension board or function extension unit performs part or all of the actual processes and the functions of the first and second embodiments are implemented by the processes is included.

As described above, in the present invention, with displaying detailed program information on a predetermined program in a screen for displaying program information, further, detailed program information on an arbitrary program can selectively be displayed, and detailed program information concerning a plurality of programs can be displayed on the same screen. Therefore, a user becomes possible to perform the selection of a desired program more easily with comparing the respective programs selected as audience program candidates as the first program, the second program, the third program, . . . , by the detailed program information.

What is claimed is:

1. A display controlling apparatus for controlling a display apparatus which displays TV program information, comprising:
receiving means for receiving program information on a plurality of programs;
display control means for controlling so as to display first program information on said plurality of programs on the basis of the program information received by said receiving means on display means; and
selection means for selecting first program information relating to an arbitrary program in the first program information displayed on said display means,
wherein said display control means controls so as to display second program information on a program relating to said first program information selected by said selection means, and controls so as to display the second program information on a plurality of said selected programs.

2. An apparatus according to claim 1, wherein
said second program information is information more detailed than said first program information.

3. An apparatus according to claim 1, wherein
said second program information includes at least one piece of information of a title of a program, information concerning contents of the program, information concerning a genre to which the program belongs, charge information to the program, and information concerning a broadcasting time of the program.

4. An apparatus according to claim 1, wherein
said first program information is displayed in the form of a program table indicating program titles with channel number information being a vertical axis (horizontal axis) and broadcasting time information on program being a horizontal axis (vertical axis).

5. An apparatus according to claim 1, wherein
said display control means controls so as to display said first program information and second program information on a program relating to said first program information selected by said selection means on the same screen.

6. An apparatus according to claim 1, wherein
said selection means can select arbitrary first program information in a state that said second program information, and
said display control means controls so as to display second program information relating to said further selected first program information on the same screen as said displayed second program information.

7. An apparatus according to claim 6, wherein
when selecting further arbitrary first program information by said selection means,
said display control means controls so as to selectively display first program information on said plurality of programs so as not to eliminate a display of the first program information selected by said selection means.

8. An apparatus according to claim 1, wherein
said display control means controls so as to fixedly display said second program information to an arbitrary area in said screen and so as to selectively display said first program information in said screen.

9. An apparatus according to claim 8, wherein
after fixedly di splaying said second program information in said arbitrary area, said display control means displays second program information relating to a program of the first program information selected by said s election means selectively in accordance with the selection operation and adjacent to said selected first program information.

10. An apparatus according to claim 8, wherein
said receiving means receives program information relating to programs transmitted by different transmission paths, and
said display control means controls so as to display a plurality of pieces of said second program information relating to programs transmitted by said different transmission paths, respectively.

11. An apparatus according to claim 10, wherein
said display control means controls so as to fixedly display said second program information in an arbitrary area in said screen and so as to selectively display first program information on a program transmitted by a transmission path different from the program of the displayed second program information in said screen.

12. An apparatus according to claim 10, wherein
said transmission paths include at least one of digital television broadcasting by a communication satellite (CS), digital broadcasting by a broadcasting satellite (BS), digital television broadcasting by ground waves, and digital television broadcasting by cable transmission.

13. A display controlling method for controlling a display apparatus which displays TV program information, comprising:
the receiving step of receiving program information on a plurality of programs;
the display control step of controlling so as to display first program information on said plurality of programs on the basis of said received program information on display means; and
the selecting step of selecting first program information relating to an arbitrary program in the first program information displayed on said display means,
wherein said display control step controls so as to display second program information on a program relating to said selected first program information, and controls so as to display the second program information on a plurality of said selected programs.

14. A method according to claim 13, wherein
said second program information is information more detailed than said first program information.

15. A method according to claim 13, wherein
said second program information includes at least one piece of information of a title of a program, information concerning contents of the program, information concerning a genre to which the program belongs, charge information to the program, and information concerning a broadcasting time of the program.

16. A method according to claim 13, wherein
said first program information is displayed in the form of a program table indicating program titles with channel number information being a vertical axis (horizontal axis) and broadcasting time information on program being a horizontal axis (vertical axis).

17. A method according to claim 13, wherein
said display control step controls so as to display said first program information and second program information on a program relating to said first program information selected by said selecting step on the same screen.

18. A method according to claim 13, wherein
said selecting step can select arbitrary first program information in a state that said second program information, and
said display control step controls so as to display second program information relating to said further selected first program information on the same screen as said displayed second program information.

19. A method according to claim 18, wherein
when selecting further arbitrary first program information by said selecting step,
said display control step controls so as to selectively display first program information on said plurality of programs so as not to eliminate a display of the first program information selected by said selecting step.

20. A method according to claim 13, wherein
said display control step controls so as to fixedly display said second program information to an arbitrary area in said screen and so as to selectively display said first program information in said screen.

21. A method according to claim 20, wherein
after fixedly displaying said second program information in said arbitrary area, said display control step displays second program information relating to a program of the first program information selected by said selecting step selectively in accordance with the selection operation and adjacent to said selected first program information.

22. A method according to claim 13, wherein
said receiving step receives program information concerning programs transmitted by different transmission paths, and
said display control step controls so as to display a plurality of pieces of said second program information relating to programs transmitted by said different transmission paths, respectively.

23. A method according to claim 22, wherein
said display control step controls so as to fixedly display said second program information in an arbitrary area in said screen and so as to selectively display first program information on a program transmitted by a transmission path different from the program of the displayed second program information in said screen.

24. A method according to claim 22, wherein
said transmission paths include at least one of digital television broadcasting by a communication satellite (CS), digital broadcasting by a broadcasting satellite (BS), digital television broadcasting by ground waves, and digital television broadcasting by cable transmission.

25. A storage medium storing program data for executing the following display controlling method:
the receiving step of receiving program information on a plurality of programs;
the display control step of controlling so as to display first program information on said plurality of programs on the basis of said received program information on display means; and
the selecting step of selecting first program information relating to an arbitrary program in the first program information displayed on said display means,
wherein said display control step controls so as to display second program information on a program relating to said selected first program information, and controls so as to display the second program information on a plurality of said selected programs.

26. A display controlling apparatus, comprising:
receiving means for receiving television signals including EPG (Electronic Program Guide) data indicating program information on a plurality of programs;
output means for outputting program table data for list-displaying program information relating to said plurality of programs on the basis of the EPG data received by said receiving means, to display means;
selection means for selecting program information relating to an arbitrary program from a list display of the program information displayed on said display means; and
display control means for controlling said display means so as to display detailed program information relating to the program of the program information on the same screen as the list display of said program information in accordance with a selection operation by said selection means,
wherein in a state that detailed program information relating to the first program selected by said selection means is displayed by said display means, said selection means can further select program information relating to an arbitrary program in the program information relating to said plurality of programs, and said display control means controls so as to display detailed program information relating to said selected second program on the same screen as the detailed program information relating to said first program.

27. An apparatus according to claim 26, wherein
said detailed program information includes at least one piece of information of a title of a program, information concerning contents of the program, information concerning a genre to which the program belongs, charge information to the program, and information concerning a broadcasting time of the program.

28. An apparatus according to claim 26, wherein
said program information is displayed in the form of a program table indicating program titles with channel number information being a vertical axis (horizontal axis) and broadcasting time information on program being a horizontal axis (vertical axis).

29. An apparatus according to claim 26, wherein
said display control means controls said display means so as to fixedly display said detailed program information to an arbitrary area in said screen and so as to selectively display said program information in said screen.

30. An apparatus according to claim 29, wherein
after fixedly displaying said detailed program information in said arbitrary area, said display control means controls so as to selectively display detailed program information relating to a program of the program information selected by said selection means in accordance with the selection operation.

31. An apparatus according to claim 26, wherein
said receiving means receives EPG data relating to programs transmitted by different transmission paths, and
said display control means controls so as to display a plurality of pieces of said detailed program information relating to programs transmitted by said different transmission paths, respectively.

32. An apparatus according to claim 31, wherein
said display control means controls so as to fixedly display said detailed program information in an arbitrary area in said screen and so as to selectively display program information on a program transmitted by a transmission path different from the program of the displayed detailed program information in said screen.

33. An apparatus according to claim 31, wherein
said transmission paths include at least one of digital television broadcasting by a communication satellite (CS), digital broadcasting by a broadcasting satellite (BS), digital television broadcasting by ground waves, and digital television broadcasting by cable transmission.

34. A display controlling method for controlling a display apparatus which displays TV program information, comprising steps of:
receiving television signals including EPG (Electronic Program Guide) data indicating program information on a plurality of programs;
outputting program table data for list-displaying program information relating to said plurality of programs on the basis of said received EPG data, to display means;
selecting program information relating to an arbitrary program from a list display of the program information displayed on said display means; and
controlling said display means so as to display detailed program information relating to the program of the program information on the same screen as the list display of said program information in accordance with said selection operation; and
in a state that detailed program information relating to said selected first program is displayed by said display means, capable of selecting program information relating to an arbitrary program in the program information relating to said plurality of programs, controlling said display means so as to display detailed program information relating to said selected second program on the same screen as the detailed program information relating to said first program.

35. A storage medium storing program data for executing the following display controlling method:
receiving television signals including EPG (Electronic Program Guide) data indicating program information on a plurality of programs;
outputting program table data for list-displaying program information relating to said plurality of programs on the basis of said received EPG data, to display means;
selecting program information relating to an arbitrary program from a list display of the program information displayed on said display means; and
controlling said display means so as to display detailed program information relating to the program of the program information on the same screen as the list display of said program information in accordance with said selection operation; and
in a state that detailed program information relating to said selected first program is displayed by said display means, capable of selecting program information relating to an arbitrary program in the program information relating to said plurality of programs, controlling said display means so as to display detailed program information relating to said selected second program on the same screen as the detailed program information relating to said first program.
